(19) United States
(12) Patent Application Publication
(10) Pub. No.: US 2008/0311394 A1
(43) Pub. Date: Dec. 18, 2008

(54) METHOD FOR PRODUCING A (METH)ACRYLIC THERMALLY CONDUCTIVE SHEET

(75) Inventors: Jun IZUMI, Sayama-shi (JP); Masayuki Takada, Sayama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SOKEN CHEMICAL & ENGINEERING CO., LTD., Toshima-ku (JP)

(21) Appl. No.: 12/197,379

(22) Filed: Aug. 25, 2008

Related U.S. Application Data
(62) Division of application No. 11/432,388, filed on May 12, 2006.

(51) Int. Cl. B32B 27/00; B32B 37/14; B32B 38/00

(52) U.S. Cl. 428/339; 156/275.5

(57) ABSTRACT

A polymerizable composition containing at least (A) a (meth)acrylic monomer or a partially polymerized material thereof, which is adjusted so that the glass transition temperature of the whole polymer component after polymerization comes to be 20° C. or less, (B) a thermally conductive inorganic filler, (C) a photopolymerization initiator and (D) a thermal polymerization initiator is disclosed. Further, a production method for a (meth)acrylic thermally conductive sheet which is characterized by applying the photopolymerizable composition in a thickness of from 0.5 mm to 10 mm on a support, laminating a protective sheet on the surface of the thus-applied layer, and then subjecting the resultant laminate to light irradiation is disclosed. In the polymerizable composition according to the invention, the (meth)acrylic monomer can be polymerized by light irradiation for a short time even without providing heating, achieving a sufficiently high polymerization ratio. Further, in the production of the thermally conductive sheet by utilizing this polymerizable composition, a semi-transparent paper can be used as a support or a protective sheet so that there is an economical advantage.

### TECHNICAL FIELD

The present invention relates to a polymerizable composition and, more particularly, to a polymerizable composition capable of efficiently completing polymerization and a production method for a (meth)acrylic thermally conductive sheet utilizing the polymerizable composition.

### BACKGROUND ART

Along with a trend toward high density and size reduction of electronic devices or the like, it has become an important problem to efficiently dissipate heat generated from these electronic devices and, as for a measure for solving this problem, it has been conducted that a thermally conductive sheet containing thermally conductive particles is bonded to a heat-generating part or the like and, then, the thus-generated heat is dissipated.

As a pressure-sensitive adhesive for the thermally conductive sheet, a methacrylic or an acrylic (hereinafter, referred to as “(meth)acrylic” for short) polymer has widely been used, since it has excellent pressure-sensitive adhesive properties.

On the other hand, as for a production method for such adhesive sheet using the (meth)acrylic polymer, since a method of photopolymerizing the polymerizable composition after application thereof has a characteristic in that there is no need of evaporating a solvent by heating, the method is favorably used.

As for a material produced by using the above-described two techniques in combination, that is, a thermally conductive sheet utilizing the photopolymerization, a material in which the thermally conductive particles and a photopolymerization initiator are dispersed and dissolved in a (meth)acrylate compound and, after the resultant solution is applied on a support, the thus-applied portion thereof undergoes light irradiation is known (see JP-A Nos. 6-88061 and 2000-281997).

However, in such thermally conductive sheet as described above, when an attempt is made to polymerize the (meth)acrylate compound only by the light irradiation for a short time, the polymerization ratio does not come to be sufficiently high and, then, there is a problem in that an odor caused by an unreacted (meth)acrylate compound remains. Further, a thermally conductive inorganic filler itself has a light-blocking effect and, then, when it is added in a large amount in order to enhance thermal conductivity, there is a problem in that the unreacted (meth)acrylate compound remains even after the light irradiation for a prolonged time.

Still further, it is essential to adopt a film having a favorable light transmittance as a support or a protective sheet on the surface of a layer applied on a support. Since a semi-transparent material such as paper blocks irradiated light, it cannot be used, to thereby cause a problem in cost. Even still further, in order to solve these problems, when a time period of the light irradiation is allowed to be long, production efficiency is deteriorated and, also, energy consumption is forced to be increased to a great extent.

Meanwhile, a method in which, for the purpose of enhancing adhesiveness, a heat-curing component comprising an epoxy type compound or the like and an epoxy curing agent such as amines or the like are added is known (see JP-A No. 2001-261722); however, even though the heat-curable components are added, the polymerization ratio of the (meth)acrylate compound itself can not be raised sufficiently high and the above-described problems still remain unsolved.

On the other hand, although there is an attempt of reducing remaining unreacted (meth)acrylate compound by reducing the polymerization inhibiting effect of oxygen in the air by means of using a system in which an organic peroxide is added to the photopolymerization initiator (see JP-W 2002-512296), the attempt is for improvement of an adhesive for a screen printing or to be discharged through a needle valve, and does not solve these problems in the case of a thermally conductive sheet. Further, the major purpose of the attempt is to allow a user of this adhesive to select photopolymerization or thermal polymerization at the time of using the adhesive, and improvement of the thermally conductive sheet is insufficient.

Therefore, a polymerizable composition in which a high polymerization ratio can be obtained even by light irradiation for a short time, that is, small light irradiation energy, and in which a sufficient polymerization ratio can be obtained even in the case of using a low-cost semi-transparent support or protective sheet and which is excellent in productivity, and a (meth)acrylic thermally conductive sheet production method using this composition is desired.

### DISCLOSURE OF THE INVENTION

In order to solve these problems, the present inventors have exerted intensive studies and found that, by simultaneously using a thermal polymerization initiator in addition to a photopolymerization initiator, sufficiently high polymerization ratio can be attained by light irradiation and the heat generated thereby, without separately heating the polymerizable composition, and thus achieved the present invention.

Namely, the invention provides a polymerizable composition which contains at least components (A) to (D):

(A) a (meth)acrylic monomer or a partially polymerized material thereof, which is prescribed such that a glass transition temperature of the whole polymer component after polymerization comes to be 20° C. or less;

(B) a thermally conductive inorganic filler;

(C) a photopolymerization initiator; and

(D) a thermal polymerization initiator.

Further, the invention provides a production method for a (meth)acrylic thermally conductive sheet comprising applying the above-described polymerizable composition on a support in a thickness of from 0.5 mm to 10 mm, laminating a protective sheet on the surface of the thus-applied composition, and, then, subjecting the resultant laminate to light irradiation.

### BEST MODE FOR CARRYING OUT THE INVENTION

The term “component (A)” as used herein means a (meth)acrylic monomer which is prescribed such that the glass transition temperature of the whole polymer component after polymerization comes to be 20° C. or less or a partially polymerized material thereof.

The term “(meth)acrylic monomer” in the component (A) as used herein means an acrylic monomer or a methacrylic monomer having only one (co)polymerizable double bond in its molecule. Such (meth)acrylic monomers include those having a functional group such as a hydroxyl group or a carboxyl group and those having no such functional group.

Among them, the (meth)acrylic monomer having no functional group is not particularly limited. Specific examples of such (meth)acrylic monomers include (meth)acrylic acid alkyl esters such as methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate, nonyl (meth)acrylate, and dodecyl (meth)acrylate; (meth)acrylic acid esters such as cyclohexyl (meth)acrylate, benzyl (meth)acrylate, phenyl ethyl (meth)acrylate, phenoxyethyl (meth)acrylate, and phenoxydiethylene glycol ester (meth)acrylate; and (meth)acrylic acid aryl esters such as phenyl (meth)acrylate, and methyl phenyl (meth)acrylate. These (meth)acrylic monomers can be used alone, or two or more of them may be used in combination. Preferably, acrylic acid alkyl esters are used and, particularly preferably, 2-ethylhexyl acrylate is used.

Meanwhile, the (meth)acrylic monomer having a functional group is, also, not particularly limited. Specific examples of such (meth)acrylic monomers include monomers having a carboxyl group such as (meth)acrylic acid; monomers having a hydroxyl group such as 2-hydroxyethyl (meth)acrylate, 3-hydroxypropyl (meth)acrylate and 4-hydroxybutyl (meth)acrylate; monomers having an aziridine group such as (meth)acryloyl aziridine and 2-aziridinyl ethyl (meth)acrylate; monomers having an epoxy group such as (meth) acrylate glycidyl ether and (meth)acrylate 2-ethylglycidyl ether; monomers having an amide group such as (meth) acrylamide, N-methylol (meth) acrylamide, N-methoxyethyl (meth) acrylamide, N-butoxymethyl (meth)acrylamide and dimethylaminomethyl (meth)acrylate; and monomers having an isocyanate group such as 2-(meth)acryloyloxyethyl isocyanate.

When any one of these (meth)acrylic monomers having a functional group is blended with an optional component (E) as described below, such blending comes to be favorable since it gives a cross-linking site to the polymer produced by the light irradiation. Particularly preferably, (meth)acrylic acid, 2-hydroxyethyl (meth)acrylate, glycidyl (meth)acrylate and the like have this characteristic.

The amount of the (meth)acrylic monomer having a functional group to be blended in the component (A) is preferably from 0.01 to 20% by mass.

As for the component (A) according to the invention, the above-described (meth)acrylic monomer may be used alone, but a partially polymerized (meth)acrylic monomer may also be used.

The term “partially polymerized (meth)acrylic monomer” as used herein is intended to indicate a polymer of the (meth)acrylic monomer which being widely dissolved in the (meth)acrylic monomer. Therefore, a polymer generated by polymerizing a portion of (meth)acrylic monomer and which is dissolved in unreacted (meth)acrylic monomer is included and, further, separate such polymers added to (meth)acrylic monomer are included. Still further, a material in which a separately polymerized material is dissolved in a (meth)acrylic monomer which may have a different composition is also included.

Examples of polymerization of a portion of the (meth)acrylic monomer include bulk polymerization of from 5 to 95% by mass (preferably, from 15 to 90% by mass) of the (meth)acrylic monomer. At the time of such bulk polymerization, a chain transfer agent can be added for adjusting the polymerization ratio.

It is necessary to prescribe the component (A) such that the glass transition temperature of the whole polymer component after polymerization comes to be 20° C. or less. The glass transition temperature is approximately constant so long as a weight average molecular weight of the polymer is 10,000 or more. By “the glass transition temperature is 20° C. or less” it is meant that the glass transition temperature of the whole polymer component when it has such a high molecular weight that the glass transition temperature does not depend on the molecular weight and comes to have a constant value is 20° C. or less. The term “whole polymer component” as used herein is intended to indicate a polymer formed by light irradiation of (meth)acrylic monomer. However, when the partially polymerized material of the (meth)acrylic monomer is used, it also indicates a mixture of polymer polymerized by bulk polymerization or the like and dissolved in the (meth)acrylic monomer. That is, the component (A) according to the invention is prescribed such that the glass transition temperature of both the mixture of the polymer in which the (meth)acrylic monomer is polymerized by the light irradiation and the polymer which is already present before the light irradiation comes to be 20° C. or less.

The amount of the polymerized material of the (meth)acrylic monomer to be blended in the component (A) is not particularly limited and is, based on the mass of the component (A), preferably, from 1 to 90% by mass and, particularly preferably, from 5 to 60% by mass. Further, the molecular weight of the polymer (polymer in partially polymerized monomer solution) which is polymerized by the bulk polymerization or the like and dissolved beforehand in the (meth)acrylic monomer is not particularly limited, but weight average molecular weight is preferably from 10,000 to 500,000.

Meanwhile, the component (B) according to the invention is a thermally conductive inorganic filler. The component (B) is not particularly limited so long as it has thermal conductivity sufficient to obtain the effect of the invention. Specific examples of such thermally conductive inorganic fillers include aluminum hydroxide, magnesium hydroxide, calcium carbonate, magnesium carbonate, calcium oxide, magnesium oxide, zinc oxide, aluminum oxide, crystalline silica, amorphous silica, titanium oxide, nickel oxide, iron oxide, copper oxide, aluminum nitride, boron nitride, silicon nitride, calcium silicate, magnesium silicate, carbon, graphite, silicon carbide, and aluminum borate whisker. Among these thermally conductive inorganic fillers, aluminum hydroxide is preferable.

Further, in the polymerizable composition according to the invention, a photopolymerization initiator is contained as the component (C). The component (C) is not particularly limited as long as it can start a polymerization reaction of the component (A) by visible light or ultraviolet light. Specific examples of such components (C) include acyl phosphine oxides such as 2,4,6-trimethylbenzoyl diphenyl phosphine oxide (trade name: Lucirin TPO; produced by BASF Aktiengesellshaft) and 2,4,6-trimethylbenzoyl phenyl ethoxyphosphine oxide (trade name: Lucirin TPO-L; produced by BASF Aktiengesellshaft); aminoketones such as 2-benzyl-2-dimethylamino-1-(4-morpholinophenyl)-butanone-1 (trade name: IRGACURE® 369; produced by Ciba Specialty Chemicals Inc.); bis-acyl phosphine oxides such as bis (2,4,6-trimethylbenzoyl)-phenyl phosphine oxide (trade name: IRGACURE® 819; produced by Ciba Specialty Chemicals Inc.), and bis(2,6-dimethoxybenzoyl)-2,4,4-trimethylpentyl phosphine oxide (trade name: CGI403; produced by Ciba Specialty Chemicals Inc.); hydroxyketones such as hydroxycyclohexyl phenyl ketone (trade name: IRGACURE® 184; produced by Ciba Specialty Chemicals Inc.), and hydroxy-2-methyl-1-phenyl-propane-1-one (trade name: Darocure 1173; produced by Ciba Specialty Chemicals Inc.); benzophenones such as benzophenone, 2,4,6-trimethyl benzophenone, and 4-methylbenzophenone; benzyl methyl ketal (trade name: Esacure KBI; available from Nihon SiberHegner K.K.); and a 2-hydroxy-2-methyl-[4-(1-methylvinyl)phenyl]propanol oligomer (trade name: Esacure KIP 150; available from Nihon SiberHegner K.K.).

Further, in the polymerizable composition according to the invention, a thermal polymerization initiator is contained as the component (D). The component (D) is not particularly limited so long as it is ordinarily used in thermal polymerization of the (meth)acrylic monomer. Specific examples of such thermal polymerization initiators include azo type thermal polymerization initiators such as 4,4′-azobis(4-cyanovaleric acid), dimethyl 2,2′-azobis(2-methyl propionate), 2,2′-azobis(4-methoxy-2,4-dimethyl valeronitrile), 2,2′-azobis(2,4-dimethyl valeronitrile), 2,2′-azobis(2-methyl propionitrile), 2,2′-azobis(2-methyl butyronitrile), 1,1′-azobis(cyclohexane-1-carbonitrile), and 1-[(1-cyano-1-methyl ethyl)azo]formamide; peroxide type thermal polymerization initiators such as cumyl hydroperoxide, cumyl peroxyneodecanoate, cyclohexanone peroxide, 1,1,3,3-tetramethyl butyl peroxyneodecanate, octanoyl peroxide, lauroyl peroxide, 3,5,5-trimethyl hexanoyl peroxide, benzoyl peroxide, t-butyl peroxypivalate, t-butyl peroxy-2-ethylhexanoate, t-butyl peroxyisobutyrate, t-butyl cumyl peroxide, t-butyl peroxyneoheptanoate, 1,1-bis(t-hexyl peroxy)cyclohexane, diisopropyl peroxydicarbonate, and 3-chloroperbenzoic acid. Among these thermal polymerization initiators, t-butyl peroxypivalate is particularly preferable.

In the polymerizable composition according to the invention, besides the component (A) to the component (D) which are essential components, a cross-linking agent can optionally be blended as the component (E). As for the component (E), a compound which can cross-link polymers polymerized by the light irradiation with each other and a multifunctional monomer having two or more (co)polymerizable double bonds are mentioned.

The compound which can cross-link the polymers with each other is not particularly limited as long as it is a compound with 2 or more functional groups, and capable of cross-linking the polymers previously obtained by the light irradiation. However, an isocyanate type cross-linking agent or an epoxy type cross-linking agent is preferable.

The isocyanate type cross-linking agent is not particularly limited so long as it is a compound having two or more isocyanate groups in a molecule thereof. Specific examples of such isocyanate type cross-linking agents include tolylene diisocyanate, hexamethylene diisocyanate, isophorone diisocyanate, xylylene diisocyanate, hydrogenated xylylene diisocyanate, diphenyl methane diisocyanate, hydrogenated diphenyl methane diisocyanate, tetramethyl xylylene diisocyanate, naphthalene diisocyanate, triphenyl methane triisocyanate, polymethylene polyphenyl isocyanate and one of these isocyanate adducts of a polyol such as trimethylol propane. These isocyanates may be used alone, or two or more of them can be used in combination.

Further, the epoxy type cross-linking agent is not particularly limited as long as it is a compound having two or more epoxy groups in its molecule. Specific examples of such epoxy type cross-linking agents include a bisphenol A epichlorohydrin type epoxy resin, ethylene glycidyl ether, polyethylene glycol diglycidyl ether, glycerin diglycidyl ether, glycerin triglycidyl ether, 1,6-hexanediol glycidyl ether, trimethylolpropane triglycidyl ether, diglycidyl aniline, diamine glycidylamine, N,N,N′,N′-tetraglycidyl-m-xylylenediamine, and 1,3-bis(N,N′-diamine glycidylaminomethyl)cyclohexane. These epoxy type cross-linking agents may be used alone, or two or more of them can be used in combination.

On the other hand, among the components (E), the multifunctional monomer is not particularly limited as long as it is a compound which has two or more (co)polymerizable double bonds derived from a (meth)acrylate group, an allyl group, a vinyl group or the like in the molecule and is photopolymerizable together with a (meth)acrylic base agent.

Specific examples of such multifunctional monomers include 1,4-butanediol di(meth)acrylate, 1,6-hexanediol di(meth)acrylate, 1,9-nonanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, pentaerythritol tetra(meth)acrylate, trimethylolpropane di(meth)acrylate, trimethylolpropane tri(meth)acrylate, allyl (meth)acrylate, vinyl (meth)acrylate, polyester (meth)acrylate, and urethane (meth)acrylate. These multifunctional monomers may be used alone, or two or more of them can be used in combination.

Contents of the component (B) to the component (E) in the polymerizable composition according to the invention are not particularly limited and respective preferable ranges and particularly preferable ranges thereof against 100 parts by mass (hereinafter, referred to simply as “parts”) of the component (A) are described below.

| | Preferable range | Particularly preferable range |
|---|---|---|
| Component (B) | 50 to 300 parts | 100 to 250 parts |
| Component (C) | 0.1 to 5 parts | 0.5 to 2 parts |
| Component (D) | 0.01 to 1 part | 0.05 to 0.5 part |
| Component (E) | 0 to 10 parts | 0.1 to 3 parts |

In the above-described blending, when the amount of the component (B) is unduly small, the thermal conductivity sometimes comes to be deteriorated and, accordingly, when the thermally conductive sheet is prepared, not only is heat dissipation effect sometimes not obtained, but also there is a case in which, due to insufficient heat accumulation, an effect of the component (D) cannot be obtained and, then, the polymerization ratio is not increased. On the other hand, even when the amount of the component (B) to be blended is larger than those in the above-described ranges, not only is a further improvement of the thermal conductivity not obtained, but there is a case in which, due to polymerization inhibition by the light blocking effect, the (meth)acrylic monomer remains unreacted or an adhesive property is reduced.

Meanwhile, when the amount of the component (C) is unduly small, the polymerization ratio is not increased and, then, there is a case in which an odor caused by remaining unreacted (meth)acrylate type monomer is generated, while, when the amount of the component (C) is unduly large, not only is an increased effect not obtained, but also there is a case in which a molecular weight of the polymer obtained by light irradiation comes to be unduly small.

The component (D) according to the invention is used in a smaller amount than ordinarily used where there is only a thermal polymerization initiator. It is natural that the lower limit of the preferable range of the component (D) is smaller than in ordinary usage. However, when the component (D) is unduly small, the efficiency of polymerization is deteriorated and, then, there is a case in which the light irradiation of a longer time is needed, the polymerization ratio is not increased, or, when a semi-transparent support or protective sheet is used, polymerization is not completed.

In the polymerizable composition according to the invention, as an optional component, (co)polymerizable monomers other than the (meth)acrylic monomer, a tackifier resin, a flame retardant, an additive or the like can be blended.

Among such optional components, examples of (co)polymerizable monomers other than the (meth)acrylic monomers include monomers each having a carbon-carbon double bond such as styrene type monomers such as styrene, α-methyl styrene, and vinyl toluene; vinyl acetate; allyl monomers such as allyl acetate and allyl glycidyl ether; monomers each containing a carboxyl group such as itaconic acid, crotonic acid, maleic anhydride, and fumaric acid; monomers containing an oxazoline group such as 2-vinyl-2-oxazoline, 2-vinyl-5-methyl-2-oxazoline, and 2-isopropenyl-2-oxazoline; and monomers each containing an organic silicic group such as vinyl trimethoxysilane, γ-methacryloxypropyl trimethoxy silane, allyl trimethoxysilane, trimethoxysilyl propyl allyl amine, and 2-methoxyethoxytrimethoxy silane.

The tackifier resin is not particularly limited, and examples include an alicyclic petroleum resin, a dicyclopentadiene type hydrogenated petroleum resin, an aliphatic hydrogenated petroleum resin, and a hydrogenated terpene resin. Examples of such alicyclic petroleum resins include Arcon P series (for example, Arcon P-70, Arcon P-90, Arcon P-100, Arcon P-125, and Arcon P-140), Arcon M series (trade names; produced by Arakawa Chemical Industry Co., Ltd.), Rigalite 90, Rigalite R-100, and Rigalite R-125 (trade names; produced by Rika-Hercules Inc.). Examples of such dicyclopentadiene type hydrogenated petroleum resins include Escorez 5000 series (for example, Escorez ECR-299D, Escorez ECR-228B, Escorez ECR-143H, Escorez ECR-327 (trade names; produced by Tonex Co., Ltd.)), and Imarv (trade name; produced by Idemitsu Petrochemical Co., Ltd.). Examples of such aliphatic hydrogenated petroleum resins include Marukarez H (trade name; produced by Maruzen Petrochemical Co., Ltd.). Examples of such hydrogenated terpene resins include Clearon P, M, and K series (produced by Yasuhara Chemical Co., Ltd.). These tackifier resins can each be added up to an extent which does not disturb the photoradical polymerization.

Further, the flame retardant is not particularly limited. Examples of such flame retardants include halogen type flame retardants such as tetrabromobisphenol A, decabromodiphenyl oxide, octabromodiphenyl ether, hexabromocyclododecane, bistribromophenoxyethane, tribromophenol, ethylenebistetrabromophthalimide, a tetrabromobisphenol A.epoxy oligomer, brominated polystyrene, ethylene bispentabromodiphenyl, chlorinated paraffin, and dodecachlorocyclooctane; and phosphorus type flame retardants such as phosphoric acid compounds, polyphosphoric acid compounds, and red phosphorus compounds. Among these flame retardants, from the standpoint of loads to be put on the environment and human bodies, the non-halogenated types are preferred. These flame retardants either in a powder state or a liquid state may be used alone, or two or more of them can be used in combination.

Further such additives as a thickening agent, a dye, a pigment, an antioxidant and the like may be used.

The polymerizable composition according to the invention to be obtained in such manner as described above can obtain a high polymerization ratio even by light irradiation for a short time.

Further, the light source to be used for the light irradiation for this polymerization is not particularly limited as long as it can irradiate light with a wavelength corresponding to the characteristics of the component (C) to be blended. Examples of such light sources include a chemical lamp, a black light lamp, a low-pressure mercury lamp, a high-pressure mercury lamp, an ultrahigh-pressure mercury lamp and a metal halide lamp, utilized as appropriate.

Making use of characteristics of the polymerizable composition according to the invention so that a high polymerization ratio can be obtained even by the light irradiation for a short time, the composition can be used, for example, for an adhesive layer for a two-sided pressure-sensitive adhesive tape, a core material for a thick tape, a damping sheet, or a ceiling sheet, and it is desirably utilized particularly in a thermally conductive sheet.

One illustrative example of a method for producing the thermally conductive sheet by utilizing the polymerizable composition according to the invention is a production method comprising applying the polymerizable composition according to the invention in a thickness of from 0.5 mm to 10 mm on a support, laminating a protective sheet on the surface of the thus-applied layer, and then, subjecting the resultant laminate to light irradiation.

In the preparation of the thermally conductive sheet according to the invention, although transparent films made of, for example, polyethylene terephthalate, polyethylene, polypropylene and an ethylene vinyl acetate copolymer can be used as the support or the protective sheet, in addition to these transparent films, semi-transparent films such as paper can be used. These films may previously be treated with surface processing such as processing for improving peeling properties.

Since the polymerizable composition according to the invention has a high polymerization efficiency, when a semi-transparent material which attenuates irradiated light is used as a support of a protective sheet, the effect of the composition is particularly exerted. In this point, since paper is low in cost, it is particularly preferred. Type of paper is not particularly limited so long as it has sufficient strength and flexibility as the support or the protective sheet and unless it substantially does not transmit light at all and, accordingly, a commercially available paper can be utilized. Specifically, high quality paper, glassine and the like are preferred. Further, a paper separator prepared by treating the glassine with peeling processing or coating the high quality paper with a polyethylene resin and, then, treating the resultant quality paper with peeling processing is preferred.

The thickness of the paper or the paper separator is not particularly limited and is preferably from 30 to 250 μm. When the thickness thereof is less than 30 μm, the paper or the paper separator can not obtain a sufficient strength and, accordingly, there is a case in which it cannot be used as the support or the protective sheet, while, when the thickness thereof is over 250 μm, there is a case in which light is not sufficiently transmitted therethrough.

Thickness of the polymerizable composition according to the invention to be applied on the support is, preferably, from 0.5 mm to 10 mm and, particularly preferably, from 1 mm to 3 mm. The light irradiation may be performed either from one side or both sides of the sheet.

It goes without saying that, after the light irradiation, in order to allow the component (D) to sufficiently act, the sheet may slightly be heated.

In the polymerizable composition and the thermally conductive sheet according to the invention, the reason for the excellent property that a high polymerization ratio can be obtained by the light irradiation for a short time is considered to be as follows.

Namely, in the polymerizable composition according to the invention, polymerization of the (meth)acrylic monomer contained therein can be sufficiently performed by light irradiation alone.

According to the invention, a photopolymerization initiator and a small amount of thermal polymerization initiator are blended in the polymerizable composition and, then, by conducting photopolymerization by the light irradiation, the action of the thermal polymerization initiator is started by the heat generated by such advancement of the photopolymerization, to thereby polymerize the monomer component which is left unpolymerized at the time of the photopolymerization.

Namely, according to the invention, different qualities of polymerization initiators are used in combination so that the photopolymerization and the thermal polymerization are simultaneously conducted and, as a result, it becomes possible to obtain an excellent polymerized material having a high polymerization ratio.

### EXAMPLES

Hereinafter, examples are given to illustrate the invention and should not be interpreted as limiting it in any way. “% by mass” and “parts by mass” are referred to as “%” and “parts” for short, respectively.

### Production Example 1

### Preparation of Partially Polymerized Material of (Meth)acrylic Monomer

920 g of 2-ethylhexyl acrylate (hereinafter, referred to as “2-EHA” for short), 80 g of acrylic acid (hereinafter, referred to as “AA” for short), and 0.6 g of n-dodecylmercaptan were put in a 2-liter four-necked flask equipped with an agitator, a thermometer, a nitrogen gas inlet tube and a condenser and, then, heated to 60° C. while replacing the air inside the flask with a nitrogen gas.

Subsequently, 0.025 g of 2,2′-azobis(4-methoxy-2,4-dimethylvaleronitrile) (trade name: V-70; produced by Wako Pure Chemical Industries, Ltd.) (hereinafter, referred to as “V-70” for short) was added as a polymerization initiator to the resultant mixture under agitation and, then, homogeneously mixed. After the polymerization initiator was added, the temperature of a reaction system rose. However, when the polymerization reaction was allowed to advance without cooling, the temperature of the reaction system reached 120° C. and, then, started to gradually fall. When the temperature of the reaction system was decreased to 115° C., the mixture was forcibly cooled, to thereby obtain a partially polymerized material of (meth)acrylic monomer (hereinafter, referred to as “partially polymerized material”). In the thus-obtained partially polymerized material P, a monomer concentration was 67%; a polymer concentration was 33%; and a weight average molecular weight of a polymer portion thereof was 210,000.

### Example 1

Based on 100 parts of the partially polymerized material obtained in Production Example 1, 200 parts of aluminum hydroxide (trade name: HIGILITE® H-42; produced by Showa Denko K. K.) (hereinafter, referred to as “H-42”) used as a component (B), 0.5 part of IRGACURE® 819 (trade name; produced by Nihon Ciba-Geigy KK) (hereinafter, referred to as “1819”) used as a photopolymerization initiator, 0.2 part of t-butyl peroxypivalate (trade name: Perbutyl PV; produced by NOF Corporation) (hereinafter, referred to as “P-PV”) used as a thermal polymerization initiator, and 0.1 part of TETRAD-X (trade name; produced by Mitsubishi Gas Chemical Co., Inc.) (hereinafter, referred to as “T-X”) used as an epoxy type cross-linking agent were added to 100 parts of the partially polymerized material and, then, mixed while performing defoaming at room temperature, to thereby obtain a photopolymerizable composition.

Subsequently, after the photopolymerizable composition was applied in a thickness of 1 mm by using a doctor blade on a paper separator (trade name: WGW-80M White; produced by Sun A. Kaken Co., Ltd.) which has previously been treated with peeling processing, the same type of paper separator was laminated on a surface of the thus-applied material in order to block it from contacting air and, then, the resultant laminate was irradiated by using a black light for 90 seconds and, subsequently, a high-pressure mercury lamp for 5 minutes, to thereby obtain a (meth)acrylic thermally conductive sheet.

With reference to the thus-obtained thermally conductive sheet, when a 90° peel strength was measured, while defining aluminum as an adherend, in accordance with Test Example described below, it was 400 g/cm, which was satisfactory.

Further, when a 1-kg holding power thereof at 80° C. was measured in accordance with Test Example described below, it held the adherend for one hour without dropping it.

### Example 2

Based on 100 parts of the partially polymerized material obtained in Production Example 1, 200 parts of H-42 used as an inorganic filler, 0.5 part of 1819 used as a photopolymerization initiator, 0.2 part of P-PV used as a thermal polymerization initiator, 0.1 part of T-X used as an epoxy type cross-linking agent, and 3 parts of black urethane particle (trade name: BURNOCK®CFB-600C; produced by Dainippon Ink and Chemicals, Inc.) (hereinafter, referred to as “CFB-600C”) were added to 100 parts of the partially polymerized material and, then, mixed while performing defoaming at room temperature, to thereby obtain a photopolymerizable composition.

Subsequently, after the photopolymerizable composition was applied in a thickness of 1 mm by using a doctor blade on a paper separator WGW, the same paper separator WGW was laminated on a surface of the thus-applied material in order to block it from contacting air and, then, the resultant laminate was irradiated by using a black light for 90 seconds and, subsequently, a high-pressure mercury lamp for 5 minutes, to thereby obtain a (meth)acrylic thermally conductive sheet.

With reference to the thus-obtained thermally conductive sheet, when a 90° peel strength was measured, while defining aluminum as an adherend, in accordance with Test Example described below, it was 400 g/cm, which was satisfactory.

Further, when a 1-kg holding power thereof at 80° C. was measured in accordance with Test Example described below, it held the adherend for one hour without dropping it.

### Comparative Example 1

Based on 100 parts of the partially polymerized material obtained in Production Example 1, 200 parts of H-42 used as an inorganic filler, 0.5 part of I819 used as a photopolymerization initiator, and 0.1 part of T-X used as an epoxy type cross-linking agent were added to 100 parts of the partially polymerized material, and then mixed while performing defoaming at room temperature, to thereby obtain a photopolymerizable composition.

Subsequently, after the photopolymerizable composition was applied in a thickness of 1 mm by using a doctor blade on a paper separator WGW, the same paper separator WGW was laminated on a surface of the thus-applied material in order to block it from contacting air and, then, the resultant laminate was irradiated by using a black light for 90 seconds and, subsequently, a high-pressure mercury lamp for 5 minutes, to thereby obtain a (meth)acrylic thermally conductive sheet.

When the thus-obtained thermally conductive sheet was visually observed, an unreacted portion was found.

### Comparative Example 2

Based on 100 parts of the partially polymerized material obtained in Production Example 1, 200 parts of H-42 used as an inorganic filler, 0.5 part of 1819 used as a photopolymerization initiator, 0.1 part of T-X used as an epoxy type cross-linking agent, and 3 parts of a black urethane particle CFB-600C were added to 100 parts of the partially polymerized material, and then mixed while performing defoaming at room temperature, to thereby obtain a photopolymerizable composition.

Subsequently, after the photopolymerizable composition was applied in a thickness of 1 mm by using a doctor blade on a paper separator WGW, the same paper separator WGW was laminated on a surface of the thus-applied material in order to block it from contacting air and, then, the resultant laminate was irradiated by using a black light for 90 seconds and, subsequently, a high-pressure mercury lamp for 5 minutes, to thereby obtain an acrylic thermally conductive sheet.

When the thus-obtained thermally conductive sheet was visually observed, an unreacted portion was found.

### Comparative Example 3

Based on 100 parts of the partially polymerized material obtained in Production Example 1, 200 parts of H-42 used as an inorganic filler, 0.5 part of P-PV used as a thermal polymerization initiator, and 0.1 part of T-X used as an epoxy type cross-linking agent were added to 100 parts of the partially polymerized material, and then mixed while performing defoaming at room temperature, to thereby obtain a polymerizable composition.

Subsequently, after the polymerizable composition was applied in a thickness of 1 mm by using a doctor blade on a transparent polyethylene terephthalate film separator (hereinafter, referred to as “PET separator”) having a thickness of 100 μm, the resultant film separator was allowed to be polymerized in a warm-air dehydrator for 10 minutes at 100° C., to thereby obtain a (meth)acrylic thermally conductive sheet.

When the thus-obtained thermally conductive sheet was visually observed, a defect in a coated film caused by foaming in the surface and a size change of PET separator caused by rapid heat generation were found.

### TEST EXAMPLES

### 90° Peel Strength

After an aluminum foil having a thickness of 50 μm was laminated on one face of an acrylic thermally conductive sheet having 25 mm wide×150 mm long, the other face of the sheet was attached to an aluminum test piece. The resultant laminate was left to stand for 30 minutes under conditions of 23° C./65% RH and, thereafter, 900 peel strength of the sheet was measured by using a tension tester (trade name: Strograph M1; manufactured by Toyo Seiki Seisaku-sho, Ltd.).

### 1-kg Holding Power

After an aluminum foil having 50 mm long×25 mm wide×200 μm thick was laminated on one face of an acrylic thermally conductive sheet having 25 mm long×25 mm wide, the other face of the sheet was attached to an aluminum test piece. The resultant laminate was placed in a dehydrator in which a temperature was adjusted to be 80° C. and, then, left to stand therein for one hour and, thereafter, applied thereon with a load of 1 kg, to thereby measure the holding power.

### INDUSTRIAL APPLICABILITY

According to the polymerizable composition of the invention, even without providing a heating step, a sufficiently high polymerization ratio of the (meth)acrylic thermally conductive sheet can be obtained by light irradiation for a short time.

Further, in the preparation of a adhesive sheet such as a thermally conductive sheet by using this polymerizable composition, it is not necessary to use a transparent support or protective sheet so that, for example, low-cost paper can be used, which is extremely advantageous.

In addition, since a heating step for polymerization is not necessary, energy consumption is small and no bubble was found in the thus-obtained sheet.

Therefore, the polymerizable composition according to the invention can widely be utilized in production of thermally conductive sheet and the like.

1-6. (canceled)

7. A method for producing a (meth)acrylic thermally conductive sheet, comprising:
applying a polymerizable composition in a thickness of from 0.5 mm to 10 mm on a support;
laminating a protective sheet on the surface of the applied polymerizable composition layer; and
polymerizing the polymerizable composition by subjecting the resultant laminate to light irradiation, wherein
the polymerizable composition, comprises components (A) to (D):
(A) a (meth)acrylic monomer or a partially polymerized material thereof, which is adjusted so that the glass transition temperature of the whole polymer component after polymerization is 20° C. or less;
(B) a thermally conductive inorganic filler;
(C) a photopolymerization initiator; and
(D) a thermal polymerization initiator.

8. The method for producing a (meth)acrylic thermally conductive sheet, according to claim 7, wherein, polymerization further comprises thermal polymerization by a thermal polymerization initiator due to polymerization heat generated by such photopolymerization.

9. A (meth)acrylic thermally conductive sheet, obtained by the method for producing a (meth)acrylic thermally conductive sheet, according to claim 7.

10. A (meth)acrylic thermally conductive sheet, obtained by the method for producing a (meth)acrylic thermally conductive sheet, according to claim 8.

11. The method for producing a (meth)acrylic thermally conductive sheet, according to claim 7, wherein, the polymerizable composition further comprising a cross-linking agent which is a component (E).

12. The method for producing a (meth)acrylic thermally conductive sheet, according to claim 11, wherein, polymerization further comprises thermal polymerization by a thermal polymerization initiator due to polymerization heat generated by such photopolymerization.

13. A (meth)acrylic thermally conductive sheet, obtained by the method for producing a (meth)acrylic thermally conductive sheet, according to claim 11.

14. A (meth)acrylic thermally conductive sheet, obtained by the method for producing a (meth)acrylic thermally conductive sheet, according to claim 12.

15. The method for producing a (meth)acrylic thermally conductive sheet, according to claim 7, wherein, the polymerizable composition comprising from 0.01 to 1 part by mass of the component (D), based on 100 parts by mass of the component (A).

16. The method for producing a (meth)acrylic thermally conductive sheet, according to claim 15, wherein, polymerization further comprises thermal polymerization by a thermal polymerization initiator due to polymerization heat generated by such photopolymerization.

17. A (meth)acrylic thermally conductive sheet, obtained by the method for producing a (meth)acrylic thermally conductive sheet, according to claim 15.

18. A (meth)acrylic thermally conductive sheet, obtained by the method for producing a (meth)acrylic thermally conductive sheet, according to claim 16.

19. The method for producing a (meth)acrylic thermally conductive sheet, according to claim 11, wherein, the polymerizable composition comprises from 0.01 to 1 part by mass of the component (D), based on 100 parts by mass of the component (A).

20. The method for producing a (meth)acrylic thermally conductive sheet, according to claim 19, wherein, polymerization further comprises thermal polymerization by a thermal polymerization initiator due to polymerization heat generated by such photopolymerization.

21. A (meth)acrylic thermally conductive sheet, obtained by the method for producing a (meth)acrylic thermally conductive sheet, according to claim 19.

22. A (meth)acrylic thermally conductive sheet, obtained by the method for producing a (meth)acrylic thermally conductive sheet, according to claim 20.
